(19) United States
(12) Patent Application Publication
(10) Pub. No.: US 2026/0269889 A1
(43) Pub. Date: Sep. 10, 2026

(54) PRECODER REFINEMENT USING DEMODULATION REFERENCE SIGNAL MEASUREMENT

(71) Applicant: QUALCOMM Incorporated, San Diego, CA (US)

(72) Inventors: Meilong JIANG, Westfield, NJ (US); Yu ZHANG, San Diego, CA (US); Jing SUN, San Diego, CA (US); Jing JIANG, San Diego, CA (US)

(21) Appl. No.: 19/071,930

(22) Filed: Mar. 6, 2025

(51) Int. Cl. H04B 7/0456; H04L 5/00

(52) U.S. Cl. CPC H04B 7/0456; H04L 5/0094

(57) ABSTRACT

Various aspects of the present disclosure generally relate to wireless communication. In some aspects, a user equipment (UE) may obtain one or more measurements associated with one or more demodulation reference signal ports. The UE may determine a precoder refinement indication based at least in part on the one or more measurements satisfying one or more respective measurement conditions. The UE may transmit, to a network node, the precoder refinement indication. Numerous other aspects are described.

### FIELD OF THE DISCLOSURE

Aspects of the present disclosure generally relate to wireless communication and specifically relate to techniques, apparatuses, and methods associated with precoder refinement using demodulation reference signal measurement.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

In some wireless communication systems, various devices may communicate using a multiple-user multiple input multiple output (MU-MIMO) scheme. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers.

### SUMMARY

Some aspects described herein relate to a user equipment (UE). The UE may include a processing system. The processing system may include one or more processors and one or more code-storing memories coupled with the one or more processors. The processing system may be configured to cause the UE to obtain one or more measurements associated with one or more demodulation reference signal (DMRS) ports. The processing system may be configured to cause the UE to determine a precoder refinement indication based at least in part on the one or more measurements satisfying one or more respective measurement conditions. The processing system may be configured to cause the UE to transmit, to a network node, the precoder refinement indication.

Some aspects described herein relate to a network node. The network node may include a processing system. The processing system may include one or more processors and one or more code-storing memories coupled with the one or more processors. The processing system may be configured to cause the network node to transmit, to a UE, one or more DMRSs. The processing system may be configured to cause the network node to receive, from the UE, a precoder refinement indication associated with one or more measurements associated with one or more DMRS ports of the UE. The processing system may be configured to cause the network node to select an updated precoder based at least in part on the precoder refinement indication.

Some aspects described herein relate to a method of wireless communication performed by a UE. The method may include obtaining one or more measurements associated with one or more DMRS ports. The method may include determining a precoder refinement indication based at least in part on the one or more measurements satisfying one or more respective measurement conditions. The method may include transmitting, to a network node, the precoder refinement indication.

Some aspects described herein relate to a method of wireless communication performed by a network node. The method may include transmitting, to a UE, one or more DMRSs. The method may include receiving, from the UE, a precoder refinement indication associated with one or more measurements associated with one or more DMRS ports of the UE. The method may include selecting an updated precoder based at least in part on the precoder refinement indication.

Some aspects described herein relate to a non-transitory computer-readable medium that stores a set of instructions for wireless communication by a UE. The set of instructions, when executed by one or more processors of the UE, may cause the UE to obtain one or more measurements associated with one or more DMRS ports. The set of instructions, when executed by one or more processors of the UE, may cause the UE to determine a precoder refinement indication based at least in part on the one or more measurements satisfying one or more respective measurement conditions. The set of instructions, when executed by one or more processors of the UE, may cause the UE to transmit, to a network node, the precoder refinement indication.

Some aspects described herein relate to a non-transitory computer-readable medium that stores a set of instructions for wireless communication by a network node. The set of instructions, when executed by one or more processors of the network node, may cause the network node to transmit, to a UE, one or more DMRSs. The set of instructions, when executed by one or more processors of the network node, may cause the network node to receive, from the UE, a precoder refinement indication associated with one or more measurements associated with one or more DMRS ports of the UE. The set of instructions, when executed by one or more processors of the network node, may cause the network node to select an updated precoder based at least in part on the precoder refinement indication.

Some aspects described herein relate to an apparatus for wireless communication. The apparatus may include means for obtaining one or more measurements associated with one or more DMRS ports. The apparatus may include means for determining a precoder refinement indication based at least in part on the one or more measurements satisfying one or more respective measurement conditions. The apparatus may include means for transmitting, to a network node, the precoder refinement indication.

Some aspects described herein relate to an apparatus for wireless communication. The apparatus may include means for transmitting, to a UE, one or more DMRSs. The apparatus may include means for receiving, from the UE, a precoder refinement indication associated with one or more measurements associated with one or more DMRS ports of the UE. The apparatus may include means for selecting an updated precoder based at least in part on the precoder refinement indication.

The systems, methods, and devices of this disclosure each have several innovative aspects, no single one of which is solely responsible for the desirable attributes disclosed herein.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

While aspects and embodiments are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments or uses may come about via integrated chip embodiments and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including antennas, radio frequency chains, power amplifiers, modulators, buffers, processor(s), interleavers, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

FIG. 1 is a diagram illustrating an example of a wireless communication network.

FIG. 2 is a diagram illustrating an example disaggregated network node architecture.

FIG. 3 is a diagram illustrating an example of multiple-user multiple input multiple output.

FIG. 4 is a diagram illustrating an example of physical channels and reference signals in a wireless network.

FIG. 5 is a diagram illustrating an example associated with precoder refinement using demodulation reference signal measurement.

FIG. 6 is a diagram illustrating an example process performed, for example, at a user equipment (UE) or an apparatus of a UE.

FIG. 7 is a diagram illustrating an example process performed, for example, at a network node or an apparatus of a network node.

FIGS. 8-9 are diagrams of example apparatuses for wireless communication.

### DETAILED DESCRIPTION

In some wireless networks, devices (e.g., at least one user equipment (UE) and at least one network node) may communicate using multiple input multiple output (MIMO) communications. In multiple-user MIMO (MU-MIMO), a transmitter device may simultaneously serve multiple receiver devices, or multiple transmitter devices may serve a single receiver device. As one example, a network node may simultaneously serve multiple UEs using MU-MIMO communications that are based at least in part on beamforming, spatial diversity, or polarization diversity.

In a time division duplex (TDD) system, a wireless network may manage spatial interference (e.g., including inter-UE interference) by utilizing a downlink MU-MIMO zero forcing (ZF) precoding technique. In some examples, the MU-MIMO ZF technique may be performed utilizing sounding reference signals (SRSs) for uplink channels. For example, an SRS may carry information used for uplink channel estimation, which may be used for precoder selection, among other examples. However, imperfections in an SRS channel may cause degraded performance in scenarios that utilize MU-MIMO ZF techniques. For example, such imperfections May include relatively high noise levels or outdated channel information (e.g., channel aging that results from relatively sparse SRS transmissions).

Additionally, in a frequency division duplex (FDD) system, the network node may utilize channel state information (CSI) feedback from UEs to manage interference. However, the CSI feedback may be prone to errors because of quantization noise and delays (e.g., outdated information). Such errors may cause suboptimal decoding and lead to (or fail to remedy) MU-MIMO interference.

For example, channel measurements (e.g., associated with the UE) and interference measurements (e.g., associated with additional, co-scheduled UEs) may be conducted using a non-zero power (NZP) CSI reference signal (CSI-RS) configured for channel measurement, and an NZP CSI-RS configured for interference measurement, respectively. Accordingly, the UE may report a relatively lower channel quality indicator (CQI) value based on observed interference, but the UE may be unable to recommend adjustments to interference precoding in order to reduce the interference.

Various aspects relate generally to a UE determining a precoder refinement indication based on measurements associated with demodulation reference signal (DMRS) ports, and the UE may transmit the precoder refinement indication to a network node. For example, the DMRS-based measurements may enable the UE to measure a precoded channel associated with the UE and one or more precoded channels associated with interfering layers (e.g., from one or more co-scheduled UEs). Some aspects more specifically relate to the UE measuring a set of DMRS ports associated with signal measurements for the UE and a set of ports associated with interference measurements for additional, co-scheduled UEs. In some aspects, the network node may select an updated precoder based on the precoder refinement indication received from the UE. Furthermore, the updated precoder may include a revised precoder that is applied to an initial precoder associated with the DMRS ports.

Particular aspects of the subject matter described in this disclosure can be implemented to realize one or more of the following potential advantages. In some examples, the described techniques can be used to reduce interference and improve spectral efficiency and throughput by enabling a UE to indicate adjustments to MU-MIMO interference precoding. Additionally, by determining the precoder refinement indication based on measurements of both signal channels and interfering channels, the UE's precoder refinement indication may address interference from the UE and from additional, co-scheduled UEs.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive MIMO, beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

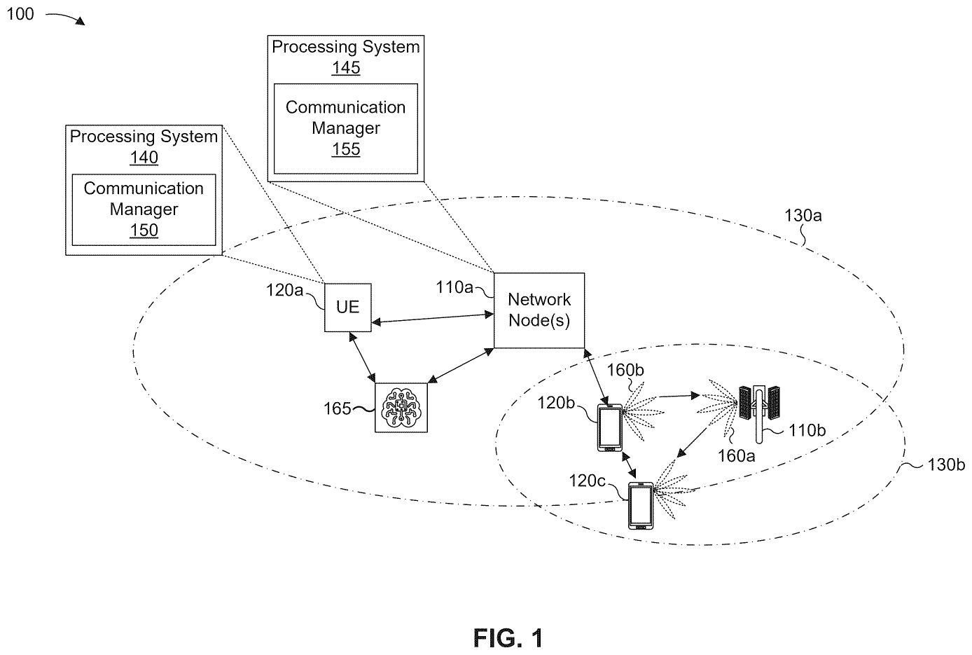

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, and as also shown, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a DMRS, a phase tracking reference signal (PTRS), a tracking reference signal (TRS), and a CSI-RS, among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a SRS, a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a CQI (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or MU-MIMO, the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples).

In some aspects, the UE 120 may include a communication manager 150. As described in more detail elsewhere herein, the communication manager 150 may obtain one or more measurements associated with one or more DMRS ports; determine a precoder refinement indication based at least in part on the one or more measurements satisfying one or more respective measurement conditions; and transmit, to a network node 110, the precoder refinement indication. Additionally, or alternatively, the communication manager 150 may perform one or more other operations described herein.

In some aspects, the network node 110 may include a communication manager 155. As described in more detail elsewhere herein, the communication manager 155 may transmit, to a UE 120, one or more DMRSs; receive, from the UE 120, a precoder refinement indication associated with one or more measurements associated with one or more DMRS ports of the UE 120; and select an updated precoder based at least in part on the precoder refinement indication. Additionally, or alternatively, the communication manager 155 may perform one or more other operations described herein.

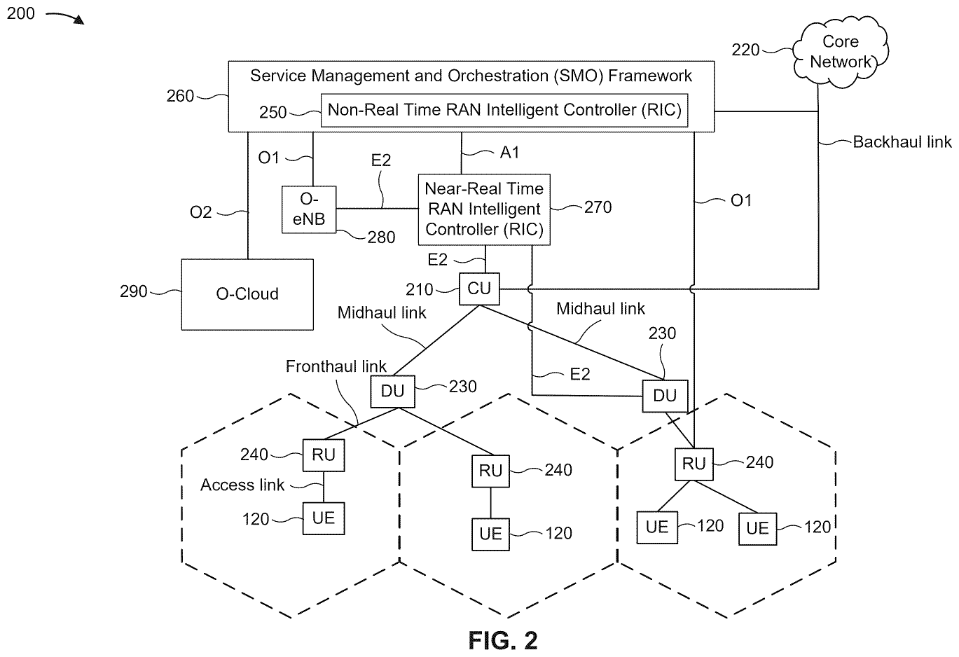

FIG. 2 is a diagram illustrating an example disaggregated network node architecture 200. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for transmitting or receiving signals, such as data, control information, or reference signals via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, or a Near-RT RIC 270. In some aspects, the SMO Framework 260 may communicate with a hardware aspect of a 4G RAN, a 5G NR RAN, or a 6G RAN, such as an open eNB (O-eNB) 280, via an O1 interface. Additionally, or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, or policy-based guidance of applications or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

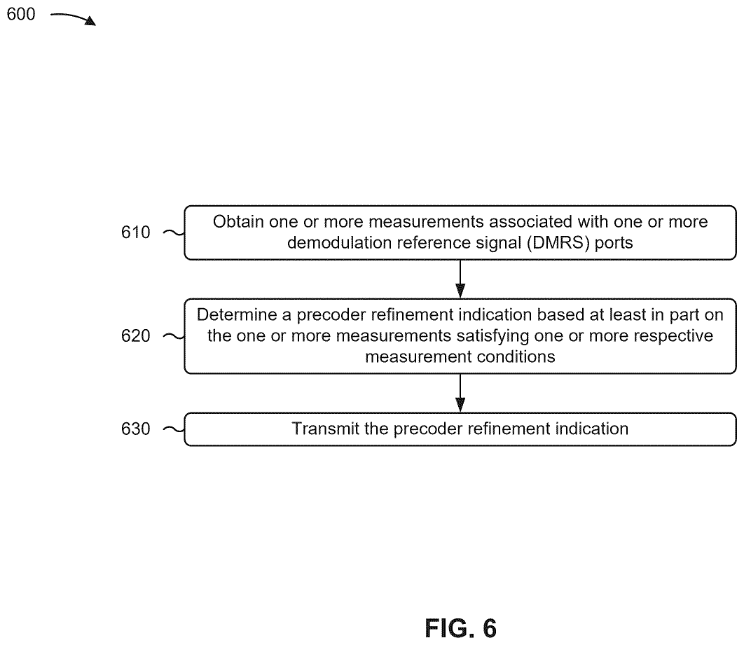

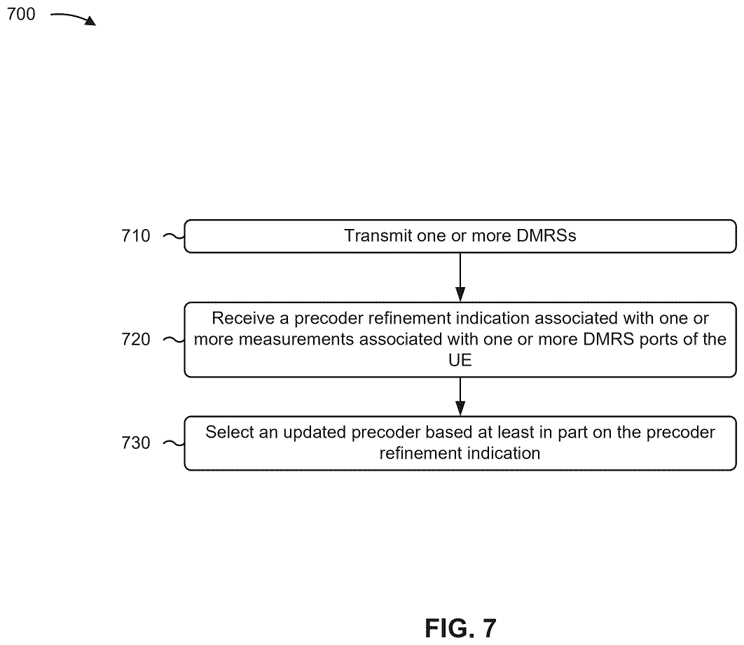

The network node 110, the processing system 145 of the network node 110, the UE 120, the processing system 140 of the UE 120, the CU 210, the DU 230, the RU 240, or any other component(s) of FIG. 1 or FIG. 2 may implement one or more techniques or perform one or more operations associated with precoder refinement using DMRS measurement, as described in more detail elsewhere herein. For example, the processing system 145 of the network node 110, the processing system 140 of the UE 120, the CU 210, the DU 230, or the RU 240 may perform or direct operations of, for example, process 600 of FIG. 6, process 700 of FIG. 7, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 600 of FIG. 6, process 700 of FIG. 7, or other processes as described herein. In some examples, executing instructions May include running the instructions, converting the instructions, compiling the instructions, or interpreting the instructions, among other examples.

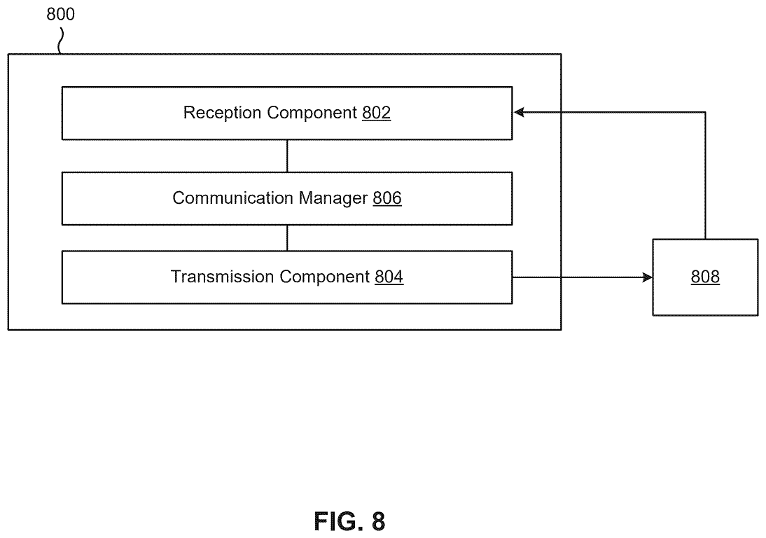

In some aspects, the UE 120 includes means for obtaining one or more measurements associated with one or more DMRS ports; means for determining a precoder refinement indication based at least in part on the one or more measurements satisfying one or more respective measurement conditions; or means for transmitting, to a network node 110, the precoder refinement indication. The means for the UE 120 to perform operations described herein may include, for example, one or more of communication manager 150, processing system 140, a radio, one or more RF chains, one or more transceivers, one or more antennas, one or more modems, a reception component (for example, reception component 802 depicted and described in connection with FIG. 8), or a transmission component (for example, transmission component 804 depicted and described in connection with FIG. 8), among other examples.

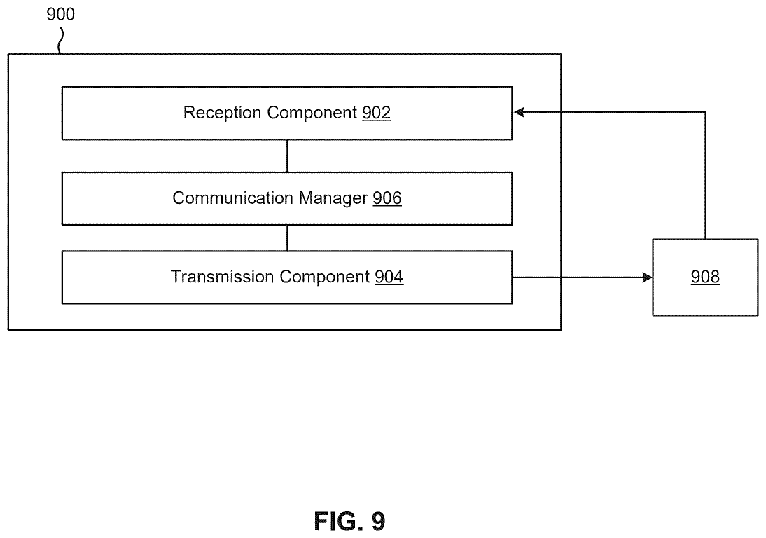

In some aspects, the network node 110 includes means for transmitting, to a UE 120, one or more DMRSs; means for receiving, from the UE 120, a precoder refinement indication associated with one or more measurements associated with one or more DMRS ports of the UE 120; or means for selecting an updated precoder based at least in part on the precoder refinement indication. The means for the network node 110 to perform operations described herein may include, for example, one or more of communication manager 155, processing system 145, a radio, one or more RF chains, one or more transceivers, one or more antennas, one or more modems, a reception component (for example, reception component 902 depicted and described in connection with FIG. 9), or a transmission component (for example, transmission component 904 depicted and described in connection with FIG. 9, among other examples.

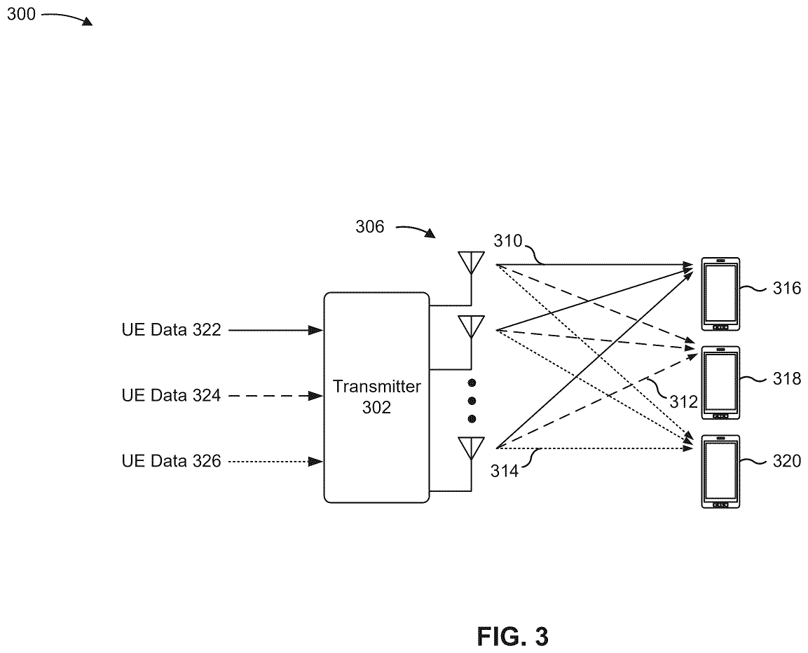

FIG. 3 is a diagram illustrating an example 300 of MU-MIMO.

In a MIMO system, the transmitter device 302 and receiver devices wirelessly communicate with one another based at least in part on multiple antennas. For example, the transmitter device 302 may include M antennas as shown by reference number 306, and a receiver device may include N antennas, where M and N are integers that may be equal or different from one another (e.g., M=N, M>N, or M<N).

In some examples, the transmitter device 302 may transmit multiple data streams via the M antennas based at least in part on using signal diversity, such as spatial diversity or polarization diversity. Typically, the number of data streams transmitted by a transmitter device is fewer than a number of antennas. That is, the mapping of the number of data streams to the number of antennas is not 1:1. Rather, each stream may be mapped with a unique set of weights to all of the available antenna such that all of the available antennas are used to transmit the multiple data streams. For example, the transmitter device 302 may transmit a first data stream 310 (shown with a solid line) using all of the M antennas and a first set of precoding weights. The first data stream 310 may include first UE data. Accordingly, each antenna of the M antenna may transmit a respective signal that carries the first data stream, and the respective signal may be precoded using a particular weight in the first set of precoding weights. Additionally, or alternatively, the transmitter device 302 may transmit a second data stream 312 (shown with a dashed line) using all of the M antennas and a second set of precoding weights, or a third data stream 314 (shown with a dotted line) using all of the M antennas and a third set of precoding weights. The second data stream 312 may include second UE data and the third data stream 314 may include third UE data. Other examples may include the transmitter device 302 transmitting each data stream using a respective subset of antennas of the M antennas. “Analog beamforming” may denote signal manipulation (e.g., the application of precoding weights) in an analog domain or an RF domain, and “digital beamforming” may denote signal manipulation in a digital domain. A transmitter device (e.g., the transmitter device 302) may perform beamforming using analog beamforming, digital beamforming, or a combination of analog beamforming and digital beamforming.

“Spatial diversity” may denote spatially diverse signal transmissions. To illustrate, and as described above, the transmitter device 302 may apply precoding to multiple signals that, when summed together, form a first beam at a first carrier frequency, where the first beam propagates in a first direction with a first spatial beamwidth. For example, the precoding may adjust respective phases or amplitudes of two or more signals that are transmitted by two or more antennas to constructively form the first beam, and the first beam may carry a first data stream. Additionally, or alternatively, the transmitter device 302 may apply precoding to multiple signals that, when summed together, form a second beam at a second carrier frequency (e.g., that may be the same carrier frequency as the first carrier frequency or a different carrier frequency from the first carrier frequency) that propagates in a second direction with a second spatial beamwidth. In some aspects, the second beam may carry a second data stream that is different from the first data stream. The transmitter device 302 may select the second propagation direction or the second spatial beamwidth to mitigate or avoid overlap with the first propagation direction or the first spatial beamwidth. That is, the first beam and the second beam may be spatially diverse based at least in part on propagating in non-overlapping directions with non-overlapping spatial beamwidths (or partially overlapping directions or spatial beamwidths).

“Polarization diversity” may denote at least two signals that have diverse polarizations. As one example, an electromagnetic (EM) wave may include an electric field (E-field) and magnetic field (H-field) that propagate along a same propagation line (e.g., a same direction) and are perpendicular to one another. For example, in an XYZ coordinate system that is characterized by an X-plane, a Y-plane, and a Z-plane that are perpendicular to one another, the E-field of the EM wave is separated from the H-field by 90 degrees. Accordingly, if an E-field that propagates along an X-axis with an amplitude that varies along the Y-axis (e.g., within a horizontal X-Y plane), the H-field may also propagate along the X-axis with an amplitude that varies along the Z-axis (e.g., in a perpendicular, vertical X-Z plane). In linear polarization, the E-field and the H-field may propagate without rotating around the propagation line, while in circular polarization, the E-field and the H-field may rotate around the propagation line. In some aspects, the transmitter device 302 may transmit a first signal that is based at least in part on a first carrier frequency and a first polarization. Additionally, or alternatively, the transmitter device 302 may transmit a second signal that is based at least in part on a second carrier frequency (e.g., that may be the same carrier frequency as the first carrier frequency or a different carrier frequency from the first carrier frequency) and a second polarization that is orthogonal to the first polarization. That is, the first signal and the second signal may have diverse polarizations. For example, the E-field of the first signal is orthogonal to the E-field of the second signal, and the H-field of the first signal is orthogonal to the H-field of the second signal. In some aspects, the first signal may carry first data, and the second signal may carry second data that is different from the first data. To illustrate, the transmitter device 302 may include at least a first antenna that is configured to generate a first signal that has a first polarization and a second antenna that is configured to generate a second signal that has a second polarization.

While the above example describes polarization with respect to orthogonal E-fields and orthogonal H-fields, other examples may use polarizations that are sufficiently decorrelated. For instance, two polarizations may be a complex weighted combination of E-field and H-field polarizations. As another example, the two polarizations may be based at least in part on a polarization distribution of the antenna elements in an antenna array. With enough decorrelation between polarizations, same or different spatial directions (e.g., transmit antenna weights), and same or different frequencies may be used for two transmission paths.

The demand for services provided by a wireless network continues to increase as more and more devices access the wireless network. A MIMO system may, in some cases, meet the demand based at least in part on the ability to simultaneously or contemporaneously transmit multiple data streams. To illustrate, and as described above, the use of multiple antennas in a MIMO system allows a transmitter device to simultaneously or contemporaneously transmit the multiple data streams using different paths (e.g., different spatial paths or different polarization paths), resulting in increased data throughput based at least in part on transmitting multiple data streams using diverse signals.

In a MU-MIMO system, the transmitter device 302 (e.g., a network node 110) may simultaneously serve multiple receiving devices (shown as a first UE 316, a second UE 318, and a third UE 320 as an example) based at least in part on beamforming, spatial diversity (e.g., spatial multiplexing), or polarization diversity (e.g., polar multiplexing). For instance, the transmitter device may simultaneously serve a first UE 316, a second UE 318, and a third UE 320 using MU-MIMO communications. For example, the transmitter device 302 may transmit first UE data 322 via the first data stream 310 (shown with a solid line) that is associated with the first UE 316 using a first beam, second UE data 324 via the second data stream 312 (shown with a dashed line) that is associated with the second UE 318 using a second beam, and third UE data 326 via the third data stream 314 (shown with a dotted line) that is associated with the third UE 320 using a third beam. The transmitter device 302 may form the first beam by applying first precoding to multiple signals (illustrated in FIG. 3 with solid lines) that, when summed together, form the first beam. In a similar manner, the transmitter device 302 may form the second beam by applying second precoding to multiple signals (illustrated in FIG. 3 with dashed lines), and may form the third beam by applying third precoding to multiple signals (illustrated in FIG. 3 with dotted lines). The multiple signals that form the first beam, the multiple signals that form the second beam, and the multiple signals that form the third beam may be simultaneously emitted by one or more of the multiple antennas shown by reference number 306. The first beam, the second beam, and the third beam may use different carrier frequencies, may use a same carrier frequency, may use different air interface resources, or may use a same air interface resource. The first UE 316, the second UE 318, and the third UE 320 may include, respectively, a single antenna port or multiple antenna ports, and each antenna port may be associated with one or more antennas of the respective UE. The simultaneous transmissions to respective devices (e.g., UEs in the example 300) may alternatively be referred to as MU-MIMO communications.

A network node may select or group UEs for MU-MIMO communications in a same time partition (e.g., a slot) based at least in part on a variety of factors that may affect MU-MIMO performance (e.g., increase or decrease data throughput). For example, the network node may select UEs based at least in part on UE location or beams that are used to communicate with the UEs. For example, the network node may select or group UEs that are associated with different beams, beams that have low correlation, or beams that have high spatial diversity. As another example, the network node may select or group UEs based at least in part on one or more signal quality metrics, such as by grouping UEs that are associated with CQI metrics that satisfy a CQI threshold or UEs that are associated with SRS signal-to-interference-plus-noise ratio (SINR) metrics that satisfy an SRS SINR threshold. For example, a UE may measure channel qualities or interference qualities associated with the UE and one or more additional UEs, and the UE may report a relatively lower (e.g., decreased) value associated with a CQI metric, based upon observed interference. Additionally, or alternatively, the network node may enable or disable MU-MIMO communications based on a variety of factors that affect MU-MIMO performance, such as a number of UEs served by the network node, a traffic load of the network node, a scatter distribution in a cell provided by the network node, or a UE distribution (e.g., location distribution) in the cell provided by the network node.

As indicated above, FIG. 3 is provided as an example. Other examples may differ from what is described with regard to FIG. 3.

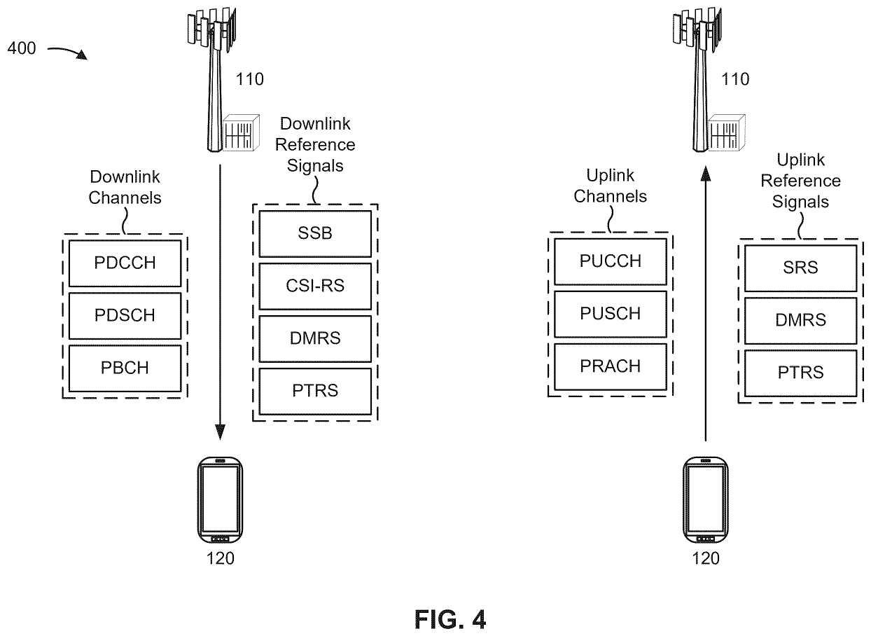

FIG. 4 is a diagram illustrating an example 400 of physical channels and reference signals in a wireless network. As shown in FIG. 4, downlink channels and downlink reference signals may carry information from a network node 110 to a UE 120, and uplink channels and uplink reference signals may carry information from a UE 120 to a network node 110.

As shown, a downlink channel may include a PDCCH that carries DCI, a PDSCH that carries downlink data, or a PBCH that carries system information, among other examples. In some aspects, PDSCH communications may be scheduled by PDCCH communications. As further shown, an uplink channel may include a PUCCH that carries UCI, a PUSCH that carries uplink data, or a PRACH used for initial network access, among other examples. In some aspects, the UE 120 may transmit ACK or NACK feedback (e.g., ACK/NACK feedback or ACK/NACK information) in UCI on the PUCCH or the PUSCH.

As further shown, a downlink reference signal may include an SSB, a CSI-RS, a DMRS, a positioning reference signal (PRS), or a PTRS, among other examples. As also shown, an uplink reference signal may include a SRS, a DMRS, or a PTRS, among other examples.

An SSB may carry information used for initial network acquisition and synchronization, such as a PSS, an SSS, a PBCH, and a PBCH DMRS. An SSB is sometimes referred to as an SS/PBCH block. In some aspects, the network node 110 may transmit multiple SSBs on multiple corresponding beams, and the SSBs may be used for beam selection.

A CSI-RS may carry information used for downlink channel estimation (e.g., downlink CSI acquisition), which may be used for scheduling, link adaptation, or beam management, among other examples. The network node 110 may configure a set of CSI-RSs for the UE 120, and the UE 120 may measure the configured set of CSI-RSs. Based at least in part on the measurements, the UE 120 may perform channel estimation and may report channel estimation parameters to the network node 110 (e.g., in a CSI report), such as a CQI, a PMI, a CRI, a LI, an RI, or an RSRP, among other examples. The network node 110 may use the CSI report to select transmission parameters for downlink communications to the UE 120, such as a number of transmission layers (e.g., a rank), a precoding matrix (e.g., a precoder), an MCS, or a refined downlink beam (e.g., using a beam refinement procedure or a beam management procedure), among other examples. For example, the UE may perform channel and interference measurements utilizing NZP CSI-RSs configured for channel measurement and NZP CSI-RSs configured for interference measurement. As a result, the UE may obtain a CQI metric for link adaptation.

A DMRS may carry information used to estimate a radio channel for demodulation of an associated physical channel (e.g., PDCCH, PDSCH, PBCH, PUCCH, or PUSCH). The design and mapping of a DMRS may be specific to a physical channel for which the DMRS is used for estimation. DMRSs are UE-specific, can be beamformed, can be confined in a scheduled resource (e.g., rather than transmitted on a wideband), and can be transmitted only when necessary. As shown, DMRSs are used for both downlink communications and uplink communications.

A PTRS may carry information used to compensate for oscillator phase noise. Typically, the phase noise increases as the oscillator carrier frequency increases. Thus, PTRS can be utilized at high carrier frequencies, such as millimeter wave frequencies, to mitigate phase noise. The PTRS may be used to track the phase of the local oscillator and to enable suppression of phase noise and common phase error (CPE). As shown, PTRSs are used for both downlink communications (e.g., on the PDSCH) and uplink communications (e.g., on the PUSCH).

A PRS may carry information used to enable timing or ranging measurements of the UE 120 based on signals transmitted by the network node 110 to improve observed time difference of arrival (OTDOA) positioning performance. For example, a PRS may be a pseudo-random Quadrature Phase Shift Keying (QPSK) sequence mapped in diagonal patterns with shifts in frequency and time to avoid collision with cell-specific reference signals and control channels (e.g., a PDCCH). In general, a PRS may be designed to improve detectability by the UE 120, which may need to detect downlink signals from multiple neighboring network nodes in order to perform OTDOA-based positioning. Accordingly, the UE 120 may receive a PRS from multiple cells (e.g., a reference cell and one or more neighbor cells), and may report a reference signal time difference (RSTD) based on OTDOA measurements associated with the PRSs received from the multiple cells. In some aspects, the network node 110 may then calculate a position of the UE 120 based on the RSTD measurements reported by the UE 120.

An SRS may carry information used for uplink channel estimation, which may be used for scheduling, link adaptation, precoder selection, or beam management, among other examples. The network node 110 may configure one or more SRS resource sets for the UE 120, and the UE 120 may transmit SRSs on the configured SRS resource sets. In some examples, a downlink MU-MIMO ZF procedure may be performed in a TDD system using SRS uplink estimation channels, in order to manage spatial interference (e.g., inter-UE interference). An SRS resource set may have a configured usage, such as uplink CSI acquisition, downlink CSI acquisition for reciprocity-based operations, uplink beam management, among other examples. The network node 110 may measure the SRSs, may perform channel estimation based at least in part on the measurements, and may use the SRS measurements to configure communications with the UE 120.

As indicated above, FIG. 4 is provided as an example. Other examples may differ from what is described with regard to FIG. 4.

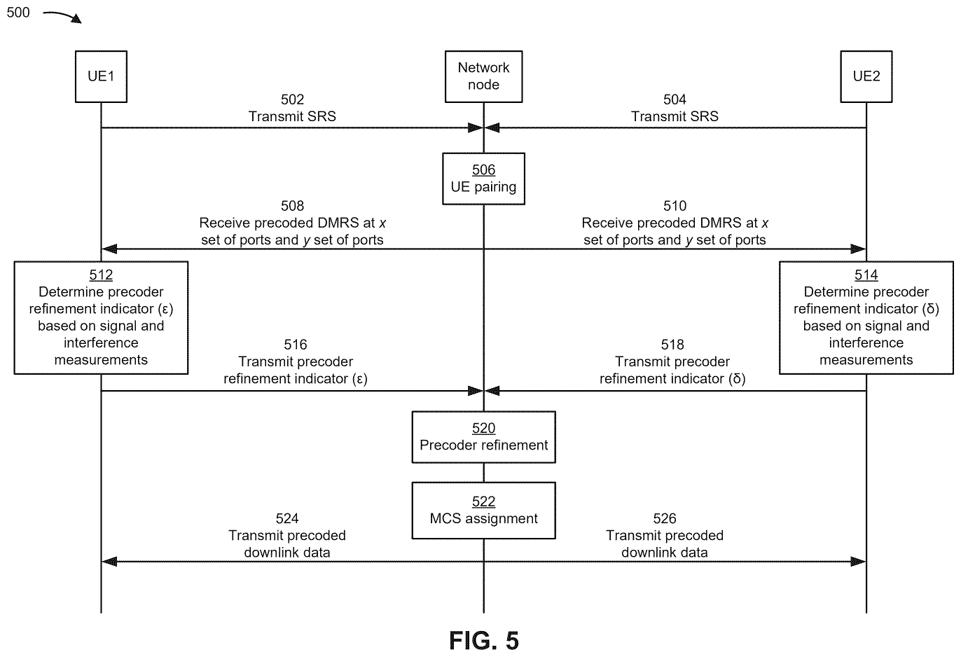

FIG. 5 is a diagram illustrating an example 500 associated with precoder refinement using DMRS measurement. As shown in FIG. 5, a network node (e.g., network node 110) may communicate with a first UE (also referred to as “UE1”) and a second UE (also referred to as “UE2”) (e.g., UEs 120).

As shown by reference number 502, the first UE may transmit, and the network node may receive, an SRS. Similarly, and as shown by reference number 504, the second UE may transmit, and the network node may receive, an SRS. For example, the SRSs transmitted from the first UE and the second UE, respectively, may include information about an uplink channel, thereby enabling the network node to perform link adaptation or to adapt uplink scheduling, beam management, or reciprocity-based downlink precoding, among other examples.

As shown by reference number 506, after the network node receives the SRSs, the network node may perform UE pairing, in which the network node may select a plurality of UEs for spatial multiplexing of time-frequency resources. For example, the network node may evaluate the SRS signal quality (e.g., SINR) and the channel correlation between the first UE and the second UE, thereby enabling the network node to pair UEs (e.g., a scheduled UE set) with low channel correlation (e.g., having distinct spatial paths) and having SRS metrics that may be likely to cause relatively low interference, or UEs with higher predicted downlink sum capacity based on an SRS estimated channel and channel reciprocity. In some aspects, the network node may compute a precoder of Pᵢ, i=0,1, for transmission of signals to multiple UEs.

As shown by reference number 508, the network node may transmit, and the first UE may receive, a precoded DMRS at a set of DMRS ports, which may include an x set of ports and a y set of ports. Additionally, and as shown by reference number 510, the network node may transmit, and the second UE may receive, the precoded DMRS at a respective set of DMRS ports, which may include a respective x set of ports and a respective y set of ports. In some aspects, the x set of ports and the y set of ports, for the first UE and the second UE, may be configured for signal and interference measurements associated with the received DMRS. In some aspects, the x set of ports may be configured to measure a signal for the associated UE, and the y set of ports may be configured to measure interference for one or more additional, co-scheduled UEs. For example, with respect to the first UE, the x set of ports may be configured to measure a signal for the first UE and the y set of ports may be configured to measure interference for one or more additional, co-scheduled UEs, including interference associated with the second UE.

In some aspects, the x set of ports may be associated with an initial precoder for the associated UE, and the y set of ports may be associated with an initial precoder that is associated with one or more additional, co-scheduled (e.g., interfering) UEs. For example, with respect to the first UE, the x set of ports (e.g., for the first UE) may be associated with an initial precoder for the first UE, and the y set of ports (e.g., for the first UE) may be associated with an initial precoder for the second UE.

Additionally, in some aspects, each port of each x set of ports (e.g., associated with the first UE or with the second UE) may be different than each port of each y set of ports (e.g., associated with the respective first UE or second UE). In other words, each x set of ports and each y set of ports, associated with a single UE, may be mutually exclusive. Alternatively, in some aspects, an x set of ports (e.g., associated with the first UE or with the second UE) may be a subset of a y set of ports (e.g., associated with the respective first UE or second UE). For example, a y set of ports may be associated with both signal measurements and interference measurements, whereas an associated x set of ports may be associated with only signal measurements.

As shown by reference number 512, the first UE may perform measurements on the DMRS ports (e.g., the x set of ports and the y set of ports). In some aspects, the first UE may perform signal measurements associated with the x set of ports, and the first UE may perform interference measurements associated with the y set of ports. Based on the signal and interference measurements, the first UE may determine a feedback metric, ¿, for a precoder refinement indication.

As shown by reference number 514, the second UE may perform measurements on the respective DMRS ports (e.g., the respective x set of ports and the respective y set of ports). In some aspects, the second UE may perform signal measurements associated with the x set of ports, and the second UE may perform interference measurements associated with the y set of ports. Based on the signal and interference measurements, the second UE may determine a feedback metric, δ, for a precoder refinement indication.

In some aspects, each UE may determine a precoder refinement indication based on the measurements associated with each UE's respective DMRS ports. For example, the first UE may determine a precoder refinement indication (e.g., ε) and the second UE may determine a precoder refinement indication (e.g., δ) according to:

$$\underline{ε} = {\underline{G}}_{00}^{- 1} {\underline{G}}_{01} , {\underline{G}}_{00} = {\underline{H}}_{0} {\underline{P}}_{0} , {\underline{G}}_{01} = {\underline{H}}_{0} {\underline{P}}_{1}$$

$$\underline{δ} = {\underline{G}}_{11}^{- 1} {\underline{G}}_{10} , {\underline{G}}_{11} = {\underline{H}}_{1} {\underline{P}}_{1} , {\underline{G}}_{10} = {\underline{H}}_{1} {\underline{P}}_{0} ,$$

where H may be associated with a single UE, G may be associated with a signal measurement, and Pᵢ may be associated with an initial precoder. For example, P₀ may be associated with a precoder for signal measurement and P₁ may be associated with a precoder for interference measurement for the current UE (e.g., associated with a precoder intended for signal measurement of additional, co-scheduled UEs).

In some aspects, a UE (e.g., the first UE or the second UE) may perform measurements based on the network node applying a signal precoder of

$$[ \begin{matrix}I \\ 0\end{matrix} ]$$

and an interference precoder of

$$[ \begin{matrix}- ε \\ I\end{matrix} ] ,$$

at the configured DMRS ports (e.g., an x set of ports and a y set of ports, respectively). For example, the received signal model for the first UE may be expressed as:

$${\underline{y}}_{0} = {\underline{G}}_{00} {\underline{x}}_{0} + {\underline{G}}_{01} {\underline{x}}_{1} + {n}_{0} = [ {\underline{G}}_{00} {\underline{G}}_{01} ] [ \begin{matrix}{\underline{x}}_{0} \\ {\underline{x}}_{1}\end{matrix} ] + {n}_{0} \text{=>} {\underline{G}}_{00} {\underline{G}}_{01} ] [ [ \begin{matrix}I & - \underline{ε} \\ 0 & I\end{matrix} ] [ \begin{matrix}{\underline{x}}_{0} \\ {\underline{x}}_{1}\end{matrix} ] + {n}_{0} = {\underline{G}}_{00} {\underline{x}}_{0} + ( {\underline{G}}_{01} - {\underline{G}}_{00} \underline{ε} ) {\underline{x}}_{1} + {n}_{0} ,$$

where G₀₀ is a signal measurement, G₀₁ is an interference measurement,

$$[ \begin{matrix}I \\ 0\end{matrix} ]$$

is associated with a signal precoder,

$$[ \begin{matrix}- ε \\ I\end{matrix} ]$$

is associated with an interference precoder, and n is associated with noise in the wireless network. For example, G₀₀=H₀P₀, G₀₁=H₀P₁ may denote a precoded signal channel and a precoded interference channel with a size nᵣ×L, where L is the rank, and may have a dimension of L×L. Additionally, H₀ may be associated with a single UE, and Pᵢ may be associated with an initial precoder. For example, P₀ may be associated with a precoder for signal measurement and P₁ may be associated with a precoder for interference measurement for the current UE (e.g., associated with a precoder intended for signal measurement of additional, co-scheduled UEs).

In some aspects, each UE may determine a precoder refinement indication based on a reduction or minimization of interference (e.g., from additional co-scheduled UEs), which may be expressed as:

$$min E {\vert {\underline{G}}_{01} - {\underline{G}}_{00} \underline{ε} \vert}^{2} \text{=>} \underline{ε} = {( {\underline{G}}_{00} )}^{†} {\underline{G}}_{01} ,$$

where † may denote a pseudoinverse.

Additionally, or alternatively, a similar procedure of determining a precoder refinement indication may be performed at the second UE, and the refined precoder for the first UE and the second UE, respectively, may be obtained as:

$$[ {\underline{P}}_{0}^{′} {\underline{P}}_{1}^{′} ] = [ {\underline{P}}_{0} {\underline{P}}_{1} ] [ \begin{matrix}I & - \underline{ε} \\ - \underline{δ} & I\end{matrix} ] = [ {\underline{P}}_{0} - {\underline{P}}_{1} \underline{δ} {\underline{P}}_{1} - {\underline{P}}_{0} \underline{ε} ] ,$$

and the respective precoder refinement indications may be transmitted to the network node, as described herein.

As shown by reference number 516, the first UE may transmit, and the network node may receive, the precoder refinement indication, ε. Similarly, and as shown by reference number 518, the second UE may transmit, and the network node may receive, the precoder refinement indication, δ.

As shown by reference number 520, the network node may refine the existing (e.g., previously-utilized) precoder based on a precoder refinement indication received from a single UE or based on one or more precoder refinement indications received from more than one UE (e.g., from the first UE and the second UE). In some aspects, the network node may select an updated precoder that includes a revised precoder that is applied to the initial precoder associated with the DMRS that was transmitted to the first UE and the second UE. In other words, the network node may select the updated precoder by applying a revised (e.g., revised based on one or more precoder refinement indications) precoder on top of the existing precoder that was previously used for transmissions and measurements (e.g., signal or interference). In some aspects, the network node may apply the updated precoder to one or more data transmission ports and one or more CQI measurement ports. As a result, use of the updated precoder may result in reduced residual interference in subsequent MU-MIMO communications.

In some aspects, the network node may select the updated precoder based on some or all of the information associated with one or more precoder refinement indications received from one or more UEs. In some aspects, the network node may select the updated precoder based on a precoder refinement indication received from a single UE. Additionally, or alternatively, the network node may refrain from selecting an updated precoder, regardless of the information associated with one or more precoder refinement indications received from one or more UEs. For example, where the network node determines that the interference levels associated with one or more UEs are acceptable, the network node may refrain from selecting an updated precoder.

Additionally, in some aspects, the network node may utilize transmitter interference cancellation (TxIC) for managing interference, where the TxIC may rely on interference precoding refinement (e.g., based on one or more received precoder refinement indications) rather than refinement based on channel estimation.

As shown by reference number 522, the network node may assign MCSs to the UEs based on an MU-CQI reported by each UE. As shown by reference number 524, the network node may transmit, and the first UE may receive, downlink data that is associated with the refined (e.g., updated) precoder. Similarly, and as shown by reference number 526, the network node may transmit, and the second UE may receive, downlink data that is associated with the refined (e.g., updated) precoder.

In some aspects, the determination of a precoder refinement indication, by one or more UEs, and the refinement of the precoder, by the network node, may be repeated according to a configured SRS periodicity or a TxIC feedback periodicity, respectively. Additionally, in some aspects, the described techniques may be utilized in a TDD mode or an FDD mode associated with the wireless network.

Additionally, or alternatively, each UE (e.g., the first UE or the second UE) may provide feedback on the resulting CQI, conditioned on the updated signal and interference precoder structure, thereby enabling the network node to further revise the precoders accordingly. For example, the first UE may receive a message, from the network node, that is associated with an updated precoder, and the UE may transmit, and the network node may receive, feedback information associated with a CQI associated with the message. In some aspects, the network node may select an updated precoder based on the feedback information.

Additionally, or alternatively, in some aspects, only a single UE (or a subset of UEs in communication with the network node) may determine and transmit a precoder refinement indication. For example, where the first UE is experiencing a relatively high level of interference, the first UE may be configured to determine and transmit the precoder refinement indication. Similarly, for example, where the second UE is experiencing relatively low levels of interference, the second UE may be configured to refrain from determining and transmitting a precoder refinement indication.

As described herein, a UE may determine a precoder refinement indication based on measurements associated with DMRS ports, and the UE may transmit the precoder refinement indication to a network node. For example, the DMRS-based measurements may enable the UE to measure a precoded channel associated with the UE and one or more precoded channels associated with interfering layers (e.g., from one or more co-scheduled UEs). Additionally, the network node may select an updated precoder based on the precoder refinement indication received from the UE. In some examples, the described techniques can be used to reduce interference and improve spectral efficiency by enabling a UE to indicate adjustments to MU-MIMO interference precoding. Additionally, by determining the precoder refinement indication based on measurements of both signal channels and interfering channels, the UE's precoder refinement indication may address interference from the UE and from additional, co-scheduled UEs.

As indicated above, FIG. 5 is provided as an example. Other examples may differ from what is described with respect to FIG. 5.

FIG. 6 is a diagram illustrating an example process 600 performed, for example, at a UE or an apparatus of a UE. Example process 600 is an example where the apparatus or the UE (e.g., UE 120) performs operations associated with precoder refinement using DMRS measurement.

As shown in FIG. 6, in some aspects, process 600 may include obtaining one or more measurements associated with one or more DMRS ports (block 610). For example, the UE (e.g., using reception component 802 or communication manager 806, depicted in FIG. 8) may obtain one or more measurements associated with one or more DMRS ports, as described above.

As further shown in FIG. 6, in some aspects, process 600 may include determining a precoder refinement indication based at least in part on the one or more measurements satisfying one or more respective measurement conditions (block 620). For example, the UE (e.g., using communication manager 806, depicted in FIG. 8) may determine a precoder refinement indication based at least in part on the one or more measurements satisfying one or more respective measurement conditions, as described above.

As further shown in FIG. 6, in some aspects, process 600 may include transmitting, to a network node, the precoder refinement indication (block 630). For example, the UE (e.g., using transmission component 804 or communication manager 806, depicted in FIG. 8) may transmit, to a network node, the precoder refinement indication, as described above.

Process 600 may include additional aspects, such as any single aspect or any combination of aspects described below or in connection with one or more other processes described elsewhere herein.

In a first aspect, a first set of DMRS ports, of the one or more DMRS ports, is associated with a set of signal measurements, and a second set of DMRS ports, of the one or more DMRS ports, is associated with a set of interference measurements.

In a second aspect, alone or in combination with the first aspect, the set of signal measurements are associated with the UE and the set of interference measurements are associated with one or more additional UEs.

In a third aspect, alone or in combination with one or more of the first and second aspects, the first set of DMRS ports is associated with an initial precoder associated with the UE, and the second set of DMRS ports is associated with an initial precoder associated with the one or more additional UEs.

In a fourth aspect, alone or in combination with one or more of the first through third aspects, each DMRS port of the first set of DMRS ports is different than each DMRS port of the second set of DMRS ports.

In a fifth aspect, alone or in combination with one or more of the first through fourth aspects, the first set of DMRS ports is a subset of the second set of DMRS ports.

In a sixth aspect, alone or in combination with one or more of the first through fifth aspects, process 600 includes receiving, from the network node, a message associated with an updated precoder.

In a seventh aspect, alone or in combination with one or more of the first through sixth aspects, the updated precoder includes a revised precoder applied to an initial precoder that is associated with the one or more DMRS ports.

In an eighth aspect, alone or in combination with one or more of the first through seventh aspects, process 600 includes receiving, from the network node, a message after the precoder refinement indication is transmitted, and transmitting, to the network node, feedback information associated with a channel quality indicator associated with the message.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, at a network node or an apparatus of a network node. Example process 700 is an example where the apparatus or the network node (e.g., network node 110) performs operations associated with precoder refinement using DMRS measurement.

As shown in FIG. 7, in some aspects, process 700 may include transmitting, to a UE, one or more DMRSs (block 710). For example, the network node (e.g., using transmission component 904 or communication manager 906, depicted in FIG. 9) may transmit, to a UE, one or more DMRSs, as described above.

As further shown in FIG. 7, in some aspects, process 700 may include receiving, from the UE, a precoder refinement indication associated with one or more measurements associated with one or more DMRS ports of the UE (block 720). For example, the network node (e.g., using reception component 902 or communication manager 906, depicted in FIG. 9) may receive, from the UE, a precoder refinement indication associated with one or more measurements associated with one or more DMRS ports of the UE, as described above.

As further shown in FIG. 7, in some aspects, process 700 may include selecting an updated precoder based at least in part on the precoder refinement indication (block 730). For example, the network node (e.g., using communication manager 906, depicted in FIG. 9) may select an updated precoder based at least in part on the precoder refinement indication, as described above.

Process 700 may include additional aspects, such as any single aspect or any combination of aspects described below or in connection with one or more other processes described elsewhere herein.

In a first aspect, process 700 includes transmitting, to one or more additional UEs, the one or more DMRSs, and receiving, from the one or more additional UEs, one or more additional precoder refinement indications, wherein the updated precoder is selected based at least in part on the one or more additional precoder refinement indications.

In a second aspect, alone or in combination with the first aspect, the one or more DMRSs are associated with a signal precoder and one or more interference precoders.

In a third aspect, alone or in combination with one or more of the first and second aspects, the signal precoder is associated with the UE and the interference precoder is associated with one or more additional UEs.

In a fourth aspect, alone or in combination with one or more of the first through third aspects, process 700 includes transmitting, to the UE, a message associated with the updated precoder.

In a fifth aspect, alone or in combination with one or more of the first through fourth aspects, the updated precoder includes a revised precoder applied to an initial precoder that is associated with the one or more DMRSs.

In a sixth aspect, alone or in combination with one or more of the first through fifth aspects, process 700 includes receiving, from the UE, feedback information associated with a channel quality indicator associated with the message.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication. The apparatus 800 may be a UE, or a UE may include the apparatus 800. In some aspects, the apparatus 800 includes a reception component 802, a transmission component 804, or a communication manager 806, which may be in communication with one another (for example, via one or more buses or one or more other components). In some aspects, the communication manager 806 is the communication manager 150 described in connection with FIG. 1. As shown, the apparatus 800 may communicate with another apparatus 808, such as a UE or a network node (such as a CU, a DU, an RU, or a base station), using the reception component 802 and the transmission component 804. The communication manager 806 may be included in, or implemented via, a processing system (for example, the processing system 140 described in connection with FIG. 1) of the UE.

In some aspects, the apparatus 800 may be configured to perform one or more operations described herein in connection with FIG. 5. Additionally, or alternatively, the apparatus 800 may be configured to perform one or more processes described herein, such as process 600 of FIG. 6. In some aspects, the apparatus 800 or one or more components shown in FIG. 8 may include one or more components of the UE described in connection with FIG. 1. Additionally, or alternatively, one or more components shown in FIG. 8 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications, and may provide the processed signals to the one or more other components of the apparatus 800. In some aspects, the reception component 802 may include one or more components of the UE described above in connection with FIG. 1, such as a radio, one or more RF chains, one or more transceivers, or one or more modems, each of which may in turn be coupled with one or more antennas of the UE.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications, and may transmit the processed signals to the apparatus 808. In some aspects, the transmission component 804 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 804 may be co-located with the reception component 802.

The communication manager 806 may support operations of the reception component 802 or the transmission component 804. For example, the communication manager 806 may receive information associated with configuring reception of communications by the reception component 802 or transmission of communications by the transmission component 804. Additionally, or alternatively, the communication manager 806 may generate or provide control information to the reception component 802 or the transmission component 804 to control reception or transmission of communications.

The reception component 802 may obtain one or more measurements associated with one or more DMRS ports. The communication manager 806 may determine a precoder refinement indication based at least in part on the one or more measurements satisfying one or more respective measurement conditions. The transmission component 804 may transmit, to a network node, the precoder refinement indication.

The reception component 802 may receive, from the network node, a message associated with an updated precoder.

The reception component 802 may receive, from the network node, a message after the precoder refinement indication is transmitted.

The transmission component 804 may transmit, to the network node, feedback information associated with a channel quality indicator associated with the message.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

FIG. 9 is a diagram of an example apparatus 900 for wireless communication. The apparatus 900 may be a network node, or a network node may include the apparatus 900. In some aspects, the apparatus 900 includes a reception component 902, a transmission component 904, or a communication manager 906, which may be in communication with one another (for example, via one or more buses or one or more other components). In some aspects, the communication manager 906 is the communication manager 155 described in connection with FIG. 1. As shown, the apparatus 900 may communicate with another apparatus 908, such as a UE or a network node (such as a CU, a DU, an RU, or a base station), using the reception component 902 and the transmission component 904. The communication manager 906 may be included in, or implemented via, a processing system (for example, the processing system 145 described in connection with FIG. 1) of the network node.

In some aspects, the apparatus 900 may be configured to perform one or more operations described herein in connection with FIG. 5. Additionally, or alternatively, the apparatus 900 may be configured to perform one or more processes described herein, such as process 700 of FIG. 7. In some aspects, the apparatus 900 or one or more components shown in FIG. 9 may include one or more components of the network node described in connection with FIG. 1. Additionally, or alternatively, one or more components shown in FIG. 9 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications, and may provide the processed signals to the one or more other components of the apparatus 900. In some aspects, the reception component 902 may include one or more components of the network node described above in connection with FIG. 1, such as a radio, one or more RF chains, one or more transceivers, or one or more modems, each of which may in turn be coupled with one or more antennas of the network node. In some aspects, the reception component 902 or the transmission component 904 may include or may be included in a network interface. The network interface may be configured to obtain or output signals for the apparatus 900 via one or more communications links, such as a backhaul link, a midhaul link, or a fronthaul link.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications, and may transmit the processed signals to the apparatus 908. In some aspects, the transmission component 904 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 904 may be co-located with the reception component 902.

The communication manager 906 may support operations of the reception component 902 or the transmission component 904. For example, the communication manager 906 may receive information associated with configuring reception of communications by the reception component 902 or transmission of communications by the transmission component 904. Additionally, or alternatively, the communication manager 906 may generate or provide control information to the reception component 902 or the transmission component 904 to control reception or transmission of communications.

The transmission component 904 may transmit, to a UE, one or more DMRSs.

The reception component 902 may receive, from the UE, a precoder refinement indication associated with one or more measurements associated with one or more DMRS ports of the UE. The communication manager 906 may select an updated precoder based at least in part on the precoder refinement indication.

The transmission component 904 may transmit, to one or more additional UEs, the one or more DMRSs.

The reception component 902 may receive, from the one or more additional UEs, one or more additional precoder refinement indications, wherein the updated precoder is selected based at least in part on the one or more additional precoder refinement indications.

The transmission component 904 may transmit, to the UE, a message associated with the updated precoder.

The reception component 902 may receive, from the UE, feedback information associated with a channel quality indicator associated with the message.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a user equipment (UE), comprising: obtaining one or more measurements associated with one or more demodulation reference signal (DMRS) ports; determining a precoder refinement indication based at least in part on the one or more measurements satisfying one or more respective measurement conditions; and transmitting, to a network node, the precoder refinement indication.

Aspect 2: The method of Aspect 1, wherein a first set of DMRS ports, of the one or more DMRS ports, is associated with a set of signal measurements, and a second set of DMRS ports, of the one or more DMRS ports, is associated with a set of interference measurements.

Aspect 3: The method of Aspect 2, wherein the set of signal measurements are associated with the UE and the set of interference measurements are associated with one or more additional UEs.

Aspect 4: The method of Aspect 3, wherein the first set of DMRS ports is associated with an initial precoder associated with the UE, and the second set of DMRS ports is associated with an initial precoder associated with the one or more additional UEs.

Aspect 5: The method of Aspect 2, wherein each DMRS port of the first set of DMRS ports is different than each DMRS port of the second set of DMRS ports.

Aspect 6: The method of Aspect 2, wherein the first set of DMRS ports is a subset of the second set of DMRS ports.

Aspect 7: The method of any of Aspects 1-6, further comprising: receiving, from the network node, a message associated with an updated precoder.

Aspect 8: The method of Aspect 7, wherein the updated precoder includes a revised precoder applied to an initial precoder that is associated with the one or more DMRS ports.

Aspect 9: The method of any of Aspects 1-8, further comprising: receiving, from the network node, a message after the precoder refinement indication is transmitted; and transmitting, to the network node, feedback information associated with a channel quality indicator associated with the message.

Aspect 10: A method of wireless communication performed by a network node, comprising: transmitting, to a user equipment (UE), one or more demodulation reference signals (DMRSs); receiving, from the UE, a precoder refinement indication associated with one or more measurements associated with one or more DMRS ports of the UE; and selecting an updated precoder based at least in part on the precoder refinement indication.

Aspect 11: The method of Aspect 10, further comprising: transmitting, to one or more additional UEs, the one or more DMRSs; and receiving, from the one or more additional UEs, one or more additional precoder refinement indications, wherein the updated precoder is selected based at least in part on the one or more additional precoder refinement indications.

Aspect 12: The method of any of Aspects 10-11, wherein the one or more DMRSs are associated with a signal precoder and one or more interference precoders.

Aspect 13: The method of Aspect 12, wherein the signal precoder is associated with the UE and the interference precoder is associated with one or more additional UEs.

Aspect 14: The method of any of Aspects 10-13, further comprising: transmitting, to the UE, a message associated with the updated precoder.

Aspect 15: The method of Aspect 14, wherein the updated precoder includes a revised precoder applied to an initial precoder that is associated with the one or more DMRSs.

Aspect 16: The method of Aspect 14, further comprising: receiving, from the UE, feedback information associated with a channel quality indicator associated with the message.

Aspect 17: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-16.

Aspect 18: An apparatus for wireless communication at a device, the apparatus comprising one or more memories and one or more processors coupled to the one or more memories, the one or more processors configured to cause the device to perform the method of one or more of Aspects 1-16.

Aspect 19: An apparatus for wireless communication, the apparatus comprising at least one means for performing the method of one or more of Aspects 1-16.

Aspect 20: A non-transitory computer-readable medium storing code for wireless communication, the code comprising instructions executable by one or more processors to perform the method of one or more of Aspects 1-16.

Aspect 21: A non-transitory computer-readable medium storing a set of instructions for wireless communication, the set of instructions comprising one or more instructions that, when executed by one or more processors of a device, cause the device to perform the method of one or more of Aspects 1-16.

Aspect 22: A device for wireless communication, the device comprising a processing system that includes one or more processors and one or more memories coupled with the one or more processors, the processing system configured to cause the device to perform the method of one or more of Aspects 1-16.

Aspect 23: An apparatus for wireless communication at a device, the apparatus comprising one or more memories and one or more processors coupled to the one or more memories, the one or more processors individually or collectively configured to cause the device to perform the method of one or more of Aspects 1-16.

Aspect 24: A device comprising a processing system that includes one or more processors and one or more code-storing memories coupled with the one or more processors, the processing system configured to cause the device to perform the method of one or more of Aspects 1-16.

Aspect 25: A device comprising a processing system that includes processor circuitry and code-storing memory circuitry, the processing system configured to cause the device to perform the method of one or more of Aspects 1-16.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE), comprising:
a processing system that includes one or more processors and one or more code-storing memories coupled with the one or more processors, the processing system configured to cause the UE to:
obtain one or more measurements associated with one or more demodulation reference signal (DMRS) ports;
determine a precoder refinement indication based at least in part on the one or more measurements satisfying one or more respective measurement conditions; and
transmit, to a network node, the precoder refinement indication.

2. The UE of claim 1, wherein a first set of DMRS ports, of the one or more DMRS ports, is associated with a set of signal measurements, and a second set of DMRS ports, of the one or more DMRS ports, is associated with a set of interference measurements.

3. The UE of claim 2, wherein the set of signal measurements are associated with the UE and the set of interference measurements are associated with one or more additional UEs.

4. The UE of claim 3, wherein the first set of DMRS ports is associated with an initial precoder associated with the UE, and the second set of DMRS ports is associated with an initial precoder associated with the one or more additional UEs.

5. The UE of claim 2, wherein each DMRS port of the first set of DMRS ports is different than each DMRS port of the second set of DMRS ports.

6. The UE of claim 2, wherein the first set of DMRS ports is a subset of the second set of DMRS ports.

7. The UE of claim 1, wherein the processing system is configured to cause the UE to:
receive, from the network node, a message associated with an updated precoder.

8. The UE of claim 7, wherein the updated precoder includes a revised precoder applied to an initial precoder that is associated with the one or more DMRS ports.

9. The UE of claim 1, wherein the processing system is configured to cause the UE to:
receive, from the network node, a message after the precoder refinement indication is transmitted; and
transmit, to the network node, feedback information associated with a channel quality indicator associated with the message.

10. A network node, comprising:
a processing system that includes one or more processors and one or more code-storing memories coupled with the one or more processors, the processing system configured to cause the network node to:
transmit, to a user equipment (UE), one or more demodulation reference signals (DMRSs);
receive, from the UE, a precoder refinement indication associated with one or more measurements associated with one or more DMRS ports of the UE; and
select an updated precoder based at least in part on the precoder refinement indication.

11. The network node of claim 10, wherein the processing system is configured to cause the network node to:
transmit, to one or more additional UEs, the one or more DMRSs; and
receive, from the one or more additional UEs, one or more additional precoder refinement indications, wherein the updated precoder is selected based at least in part on the one or more additional precoder refinement indications.

12. The network node of claim 10, wherein the one or more DMRSs are associated with a signal precoder and one or more interference precoders.

13. The network node of claim 12, wherein the signal precoder is associated with the UE and the interference precoder is associated with one or more additional UEs.

14. The network node of claim 10, wherein the processing system is configured to cause the network node to:
transmit, to the UE, a message associated with the updated precoder.

15. The network node of claim 14, wherein the updated precoder includes a revised precoder applied to an initial precoder that is associated with the one or more DMRSs.

16. The network node of claim 14, wherein the processing system is configured to cause the network node to:
receive, from the UE, feedback information associated with a channel quality indicator associated with the message.

17. A method of wireless communication performed by a user equipment (UE), comprising:
obtaining one or more measurements associated with one or more demodulation reference signal (DMRS) ports;
determining a precoder refinement indication based at least in part on the one or more measurements satisfying one or more respective measurement conditions; and
transmitting, to a network node, the precoder refinement indication.

18. The method of claim 17, wherein a first set of DMRS ports, of the one or more DMRS ports, is associated with a set of signal measurements, and a second set of DMRS ports, of the one or more DMRS ports, is associated with a set of interference measurements.

19. The method of claim 18, wherein the set of signal measurements are associated with the UE and the set of interference measurements are associated with one or more additional UEs.

20. The method of claim 17, further comprising:
receiving, from the network node, a message after the precoder refinement indication is transmitted; and
transmitting, to the network node, feedback information associated with a channel quality indicator associated with the message.
